(19) United States
(12) Patent Application Publication
(10) Pub. No.: US 2022/0188689 A1
(43) Pub. Date: Jun. 16, 2022

(54) GRAPH-TO-SIGNAL DOMAIN BASED DATA INTERCONNECTION CLASSIFICATION SYSTEM AND METHOD

(71) Applicant: JPMorgan Chase Bank, N.A., New York, NY (US)

(72) Inventors: Yawwani GUNAWARDANA, Southampton (GB); Ramesh BISESSAR, New York, NY (US); Kevin PARSONS, New York, NY (US); Karthick MURUGANANTHAM, Ferndown (GB); Zhencheng TAN, New York, NY (US); Deniz MURADOV, New York, NY (US); Joanne CUNNINGHAM, New York, NY (US)

(73) Assignee: JPMorgan Chase Bank, N.A., New York, NY (US)

(21) Appl. No.: 17/117,950

(22) Filed: Dec. 10, 2020

(51) Int. Cl. G06N 20/00; G06F 16/901

(52) U.S. Cl. CPC G06N 20/00; G06F 16/9024

(57) ABSTRACT

A system and method for performing a projected graph based prediction is provided. The method includes obtaining data from a plurality of servers, determining data entities and dataflows between the data entities based on the obtained data, and generating a first graph including the data entities as nodes and the dataflows between the nodes. The method further includes identifying data concepts based on the obtained data and modifying the first graph by inserting the identified data concepts to provide a second graph. The second graph is further projected to generate a sub-graph, which is then utilized for a prediction algorithm to determine a predicted dataflow between at least two nodes connected to a data concept in the sub-graph.

### BACKGROUND

### 1. Field of the Disclosure

This technology generally relates to methods and systems for acquiring data from multiple sources for generating a graph indicating a relationship of the acquired data, and more particularly, to methods and systems for performing graph algorithms to generate a sub-graph structure for predicting relationship on data entities with respect to a data concept.

### 2. Background Information

An organization may process more than 1 trillion messages and events on a daily basis. Based on this large amount of data, users may run more than a million jobs against such data, spanning everything from reporting and analysis to machine learning.

Given the large amount of data that is generated on a daily basis, identification of relationship of data moving within the organization with respect to other data, application, departments, people and the like for classification is difficult, which may lead to many technical and organizational inefficiencies.

The generated data may be analyzed based on the limited meta that is initially provided. As the generated data may not provide additional information than the meta originally specified, relationships between various data sets may be difficult to be determined without deeper introspection of the underlying data.

Common challenge for many users is that densely and unevenly connected data may be troublesome to analyze with traditional analytical tools, requiring more detailed introspection of contents of data. Although a structure may be present, it may be difficult to find. It's tempting to take an averages approach to messy data, but doing so may potentially conceal patterns and ensure that provided results are not representing any real groups.

Accordingly, there is a need for a methodology that aggregates and generate machine learned relationship between the aggregated data for automated classification.

### SUMMARY

The present disclosure provides utilizing data collected from various sources, such as machined system log database, asset level information database, monitoring system database and reference feed database for generating a graph, which displays of relationship between the collected data in terms of data nodes and dataflow therebetween. The generated graph may be further modified via a graph algorithm, for which a prediction algorithm may be executed for predicting dataflow relationships or data connection correlation between various data nodes provided on the modified graph. In an example, the predicted data connection correlation may provide supplemental information to specify how a critical application is compared to another and where it resides within the organization.

Communities tend to cluster around related factors, and inference of a communication behavior may be made if the structures and interactions within the captured data are understood. In this regard, graph analytics may be utilized to predict group resiliency based on its focus on relationships. Centrality is about understanding which nodes are more important in a network. Community detection connectedness is a concept of graph theory that enables a sophisticated network analysis, such as finding communities.

The present disclosure further derives a probability for determining when to use a different connection concepts, based on the number of links that overlap within the graph domain. Networks are powerful representations of interactions in complex systems with a wide range of applications. Modeling interactions between entities (or nodes) as links between nodes in a graph provides a graphical display of influence, community structure and other patterns, allows a prediction to be made regarding the interactions and usual and unusual activity more available based on real world changes and data meta flows.

Moreover, non-limiting aspects of the present application improve, via the graph topologies, an accuracy and performance of unsupervised machine learning by taking advantage of a multidimensional correlation structure. Using derived and real dataflow network connection, the system of the present disclosure outperforms machine learning neural network. For example, the outperformance may be attributable to dynamic application of weighted correlated values based on observed dataflows.

The present disclosure, through one or more of its various aspects, embodiments, and/or specific features or sub-components, provides, inter alia, various systems, servers, devices, methods, media, programs, and platforms for performing a projected graph based prediction.

According to an aspect of the present disclosure, a method for performing a projected graph based prediction is provided. The method is implemented by at least one processor. The method includes: obtaining, by the at least one processor and via a network, a plurality of data from a plurality of servers; determining, by the at least one processor and based on the obtained data, a plurality of data entities and a plurality of dataflows between the data entities; generating, by the at least one processor, a first graph including the data entities as nodes and the dataflows between the nodes: identifying, by the at least one processor, a plurality of data concepts based on the obtained data; inserting, by the at least one processor and onto the first graph, the identified data concepts to provide a second graph; applying, by the at least one processor, a graph projection on the second graph to generate a sub-graph; and determining, by the at least one processor and using a prediction algorithm via a plurality of machine learning models, a predicted dataflow between at least two nodes connected to a target data concept in the sub-graph.

According to another aspect of the present disclosure, the plurality of data includes system log data, asset level data, monitoring data, and reference data.

According to an aspect of the present disclosure, the reference data includes a dynamic network architecture corresponding to a dataflow between the nodes among the dataflows.

According to an aspect of the present disclosure, at least one of the data concepts is connected to a plurality of dataflows.

According to an aspect of the present disclosure, each of the plurality of data concepts is inputted to a corresponding machine learning model among the plurality of machine learning models.

According to an aspect of the present disclosure, the graph projection includes modifying a tripartite graph structure to a bipartite graph structure.

According to an aspect of the present disclosure, the graph projection includes modifying n-number partite graph structure to a bipartite graph structure.

According to an aspect of the present disclosure, probabilities of the predicted dataflow are calculated for the plurality of data concepts.

According to an aspect of the present disclosure, a computing apparatus for performing a projected graph. based prediction is provided. The computing apparatus includes a processor, a memory, and a communication interface coupled to each of the processor and the memory. The processor is configured to obtain, via a network, a plurality of data from a plurality of servers; determine, based on the obtained data, a plurality of data entities and a plurality of dataflows between the data entities, generate a first graph including the data entities as nodes and the dataflows between the nodes; identify a plurality of data concepts based on the obtained data; insert onto the first graph, the identified data concepts to provide a second graph; apply a graph projection on the second graph to generate a sub-graph; and determine, using a prediction algorithm via a plurality of machine learning models, a predicted dataflow between at least two nodes connected to a target data concept in the sub-graph.

According to an aspect of the present disclosure, a non-transitory computer readable storage medium that stores a computer program for performing a projected graph based prediction is provided. The computer program, when executed by a processor, causing a system to perform a process including: obtaining, via a network, a plurality of data from a plurality of servers; determining, based on the obtained data, a plurality of data entities and a plurality of dataflows between the data entities; generating a first graph including the data entities as nodes and the dataflows between the nodes; identifying a plurality of data concepts based on the obtained data; inserting, onto the first graph, the identified data concepts to provide a second graph; applying a graph projection on the second graph to generate a sub-graph; and determining, using a prediction algorithm via a plurality of machine learning models, a predicted dataflow between at least two nodes connected to a target data concept in the sub-graph.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 illustrates an exemplary system for implementing a method for performing a graph projection and a projected graph based prediction.

FIG. 4 is a flowchart of an exemplary method for performing a graph projection and a projected graph based prediction.

FIGS. 5A-5B illustrate an exemplary graph that is generated from harvest data feeds and reference data feeds.

FIGS. 6A-6C illustrate an exemplary graph to which a graph projection is applied for predicting a proximity of linkage between multiple nodes.

FIG. 7 illustrates an exemplary process for calculating prediction scores for multiple data concepts for a target dataflow between two nodes.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that when executed by one or more processors, cause the processors to carry out steps necessary to implement the methods of the examples of this technology that are described and illustrated herein.

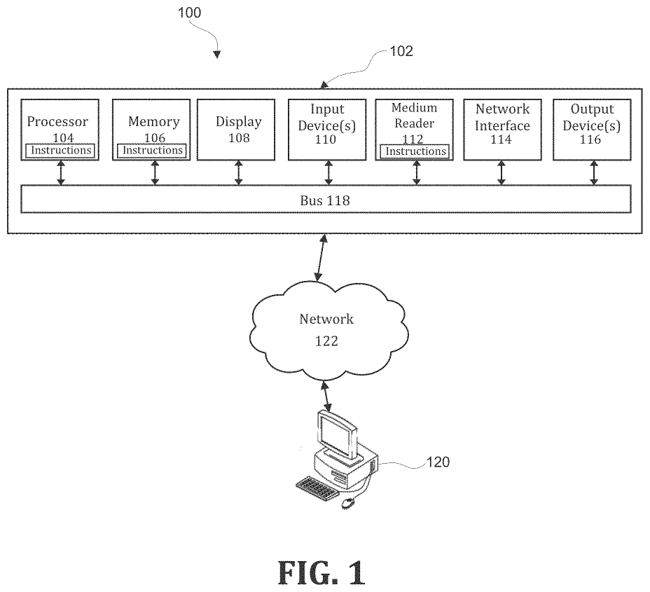

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general purpose processor or may be part of an application specific integrated circuit (ASIC). The processor 104 may also be a microprocessor, a microcomputer, a processor chip, a controller, a microcontroller, digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. The processor 104 may include a quantum processor and/or a photonic processor. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. The computer memory 106 may include a quantum memory. Memories described herein are tangible storage mediums that can store data and executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, Blu-ray disk, or any other form of storage medium known in the art. Memories may be volatile or non-volatile, secure and/or encrypted, unsecure and/or encrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected. and communicate via a bus 118 or other communication link. As shown in FIG. 1, the components may each be interconnected and communicate via an internal bus. However, those skill d in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide methods and systems for performing a graph projection and a projected graph based prediction.

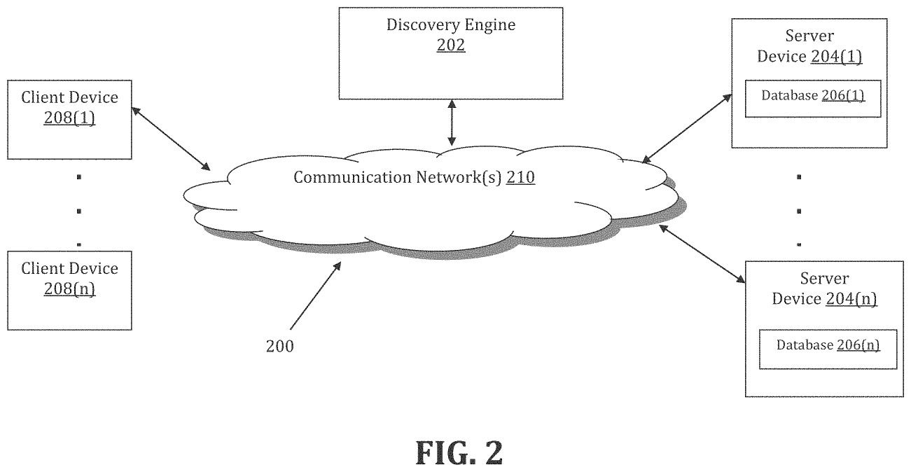

Referring to FIG. 2, a schematic of an exemplary network environment 200 for implementing a method for performing a graph projection and a projected graph based prediction is illustrated. In an exemplary embodiment, the method is executable on any networked computer platform, such as, for example, a personal computer (PC).

The method for performing a graph projection and a projected graph based. prediction in a manner that is implementable in various computing platform environments may be implemented by a computer storing a discovery engine (discovery engine computer) 202. The discovery engine computer 202 may be the same or similar to the computer system 102 as described with respect to FIG. 1. The discovery engine computer 202 may store one or more applications that can include executable instructions that, when executed by the discovery engine computer 202, cause discovery engine computer 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the discovery engine computer 202 itself, may be located in virtual server(s) running in a cloud-based computing environment rather than being tied to one or more specific physical network computing devices. Also, the application(s) may be running in one or more virtual machines (VMs) executing on the discovery engine computer 202. Additionally, in one or more embodiments of this technology, virtual machine(s) running on discovery engine computer 202 may be managed or supervised by a hypervisor.

In the network environment 200 of FIG. 2, the discovery engine computer 202 is coupled to a plurality of server devices 204(1)-204(n) that hosts a plurality of databases 206(1)-206(n), and also to a plurality of client devices 208(1)-208(n) via communication network(s) 210. A communication interface of the discovery engine computer 202, such as the network interface 114 of the computer system 102 of FIG. 1, operatively couples and communicates between the discovery engine computer 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the discovery engine computer 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 may include quantum network(s) and/or optical network(s). The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The discovery engine computer 202 may be a standalone device or integrated with one or more other devices or apparatuses, such as one or more of the server devices 204(1)-204(n), for example. In one particular example, the discovery engine computer 202 may include or be hosted by one of the server devices 20(1)-204(n), and other arrangements are also possible. Moreover, one or more of the devices of the discovery engine computer 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the discovery engine computer 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that are utilized to perform a graph projection and a projected graph based prediction.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture. for example. Thus the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the discovery engine computer 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. in an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the discovery engine computer 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the discovery engine computer 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the discovery engine computer 202, the server devices 204(1)-204(n), or the client devices 208(1)-208(n), for example, may be configured to operate as virtual instances on the same physical machine. in other words, one or more of the discovery engine computer 202, the server devices 204(1)-204(n), or the client devices 208(1)-208(n) may operate on the same physical device rather than as separate devices communicating through communication network(s) 210. Additionally, there may be more or fewer discovery engine computer 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs) the Internet, intranets, and combinations thereof.

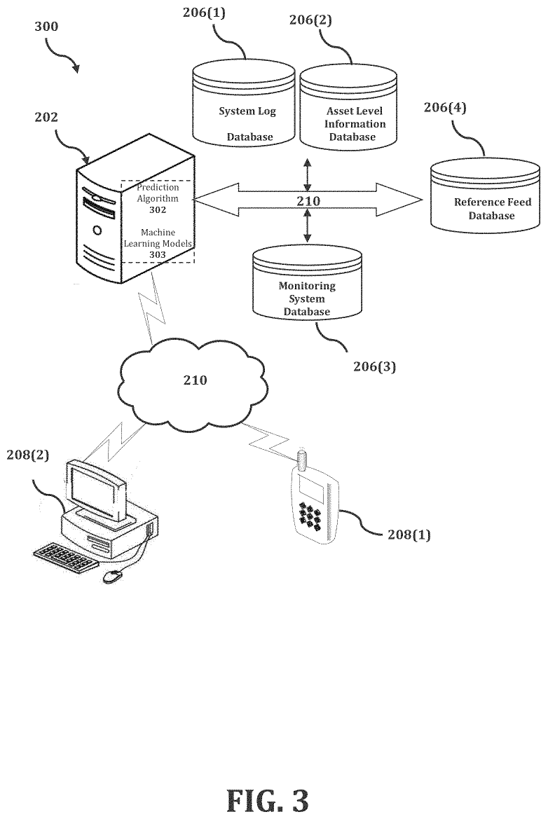

The discovery engine computer 202 is described and shown in FIG. 3 as including a prediction algorithm 302 and machine learning models 303, although it may include other rules, policies, modules, databases, or applications, for example. As will be described below, the prediction algorithm 302 and machine learning models 303 are configured to perform a graph projection and a projected graph based prediction.

An exemplary process 300 for implementing a method for performing graph projection and graph based prediction by utilizing the network environment of FIG. 2 is shown as being executed in FIG. 3. Specifically, a first client device 208(1) and a second client device 208(2) are illustrated as being in communication with the discovery engine computer 202. In this regard, the first client device 208(1) and the second. client device 208(2) may be “clients” of the discovery engine computer 202 and are described herein as such. Nevertheless, it is to be known and understood that the first client device 208(1) and/or the second client device 208(2) need not necessarily be “clients” of the discovery engine computer 202, or any entity described in association therewith herein. Any additional or alternative relationship may exist between either or both of the first client device 208(1) and the second client device 208(2) and the discovery engine computer 202, or no relationship may exist.

Further, the discovery engine computer 202 is illustrated as being able to obtain or receive data from system log database 206(1), asset level information database 206(2), monitoring system database 206(3), and reference feed database 206(4). The discovery engine computer 202 may be configured to access these databases for generating a graph, performing a graph projection and performing projected graph based predictions.

The system log database 206(1) may store system log information, which may include, for example, information of operations performed by one or more devices, such as information sent, sender information, recipient information, type of information, time of sending at the like. The asset level information database 206(2) may store, for example, machine identifier, application being utilized, user identification, organization identification and the like. The monitoring system database 206(3) may store, for example. IP addresses, data/transaction anomaly, and the like. The reference feed database 206(4) may store, for example, core capability information of various entities present in the network, data network architecture (DNA), business concepts, data taxonomy and the like.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the discovery engine computer 202 via broadband or cellular communication. Of course, these embodiments are merely exemplary and are not limiting or exhaustive.

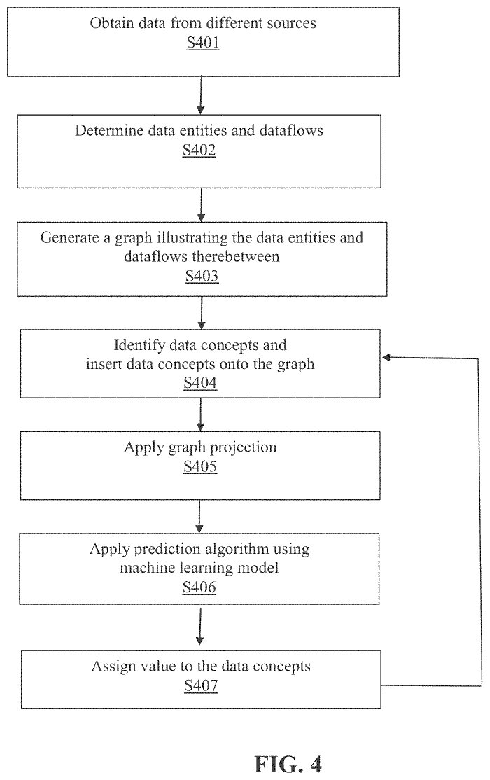

FIG. 4 shows an exemplary method for performing a projected graph based prediction, according to an aspect of the present disclosure.

In operation S401, a server hosting a discovery engine, obtains data (harvest feed) from multiple different sources or servers via a network. The obtained data may include, without limitation, system log data, asset level information, monitoring system data and the like. The system log data may include, for example, information of operations performed by one or more devices, such as information sent, sender information, recipient information, type of information, time of sending at the like. The asset level information may include, far example, machine identifier, application being utilized, user identification, organization identification and the like. Monitoring system data may include, for example, IP addresses, data/transaction anomaly, and the like. The obtained data may optionally may he cleaned, selected and curated. The harvest feed data may be limited to description or basic information, without including information of underlying data for more efficient transmission.

In addition, the server hosting the discovery engine may also receive one or more reference data feeds from one or more servers. The reference data may include, without limitation, core capability information of various entities present in the network, data network architecture (DNA), business concepts, data taxonomy and the like. In an example, DNA may indicate a concept with respect to a particular dataflow.

The reference data may include machine generated information or manually annotated information. In an example, the harvest data and the reference data may be received contemporaneously or at different times.

In operation S402, based on the harvest feed obtained in S401, data entities present in the network, as well as dataflows from one entity to another may be identified. The determined data entities may be depicted as various nodes on a generated display. Data entities may include, without limitation, various applications utilized within an organization. Further, dataflows and direction of flow may be determined based on the obtained data. For example, data entities present in the network may include App A and App B, and a dataflow may indicate that App A sends data to App B.

In operation S403, a graph illustrating interconnections between the identified data entities may be generated. Further, a dataflow may also be illustrated in the generated graph. For example, the generated graph may illustrate one application (e.g., App A) sending a message to another application (e.g., App B). In this example, the graph may illustrate a dataflow from App A to App B. Based on the generated graph, an overview of communication interconnectivity between various applications across the network may be provided.

In an example, a population of associations between nodes may be referred to as capabilities. Based on the generated graph, a statistical probability that organization capability A sends to organization capability B and/or vice versa, and statistical probability that dataflow A sends or receives from from/to dataflow B may be calculated.

The generated graph may additionally indicate a degree, closeness, between-ness, and page rank of various nodes. For example, the degree may indicate a number of connections with other nodes that a particular node made have. Closeness may indicate which node can most easily reach all other nodes in a graph or a subgraph. Between-ness may indicate which node has most control over flow between nodes and groups. Page-rank may indicate which node is the most important.

In operation S404, data concepts are identified based on the obtained reference data feeds and inserted into the generated graph. In an example, reference data feed, such as DNA, may indicate a particular concept for a particular dataflow. DNAs may indicate the same or similar concept across many dataflows, or may indicate a concept unique to the dataflow. DNAs may be generated as additional graphical nodes in the graph.

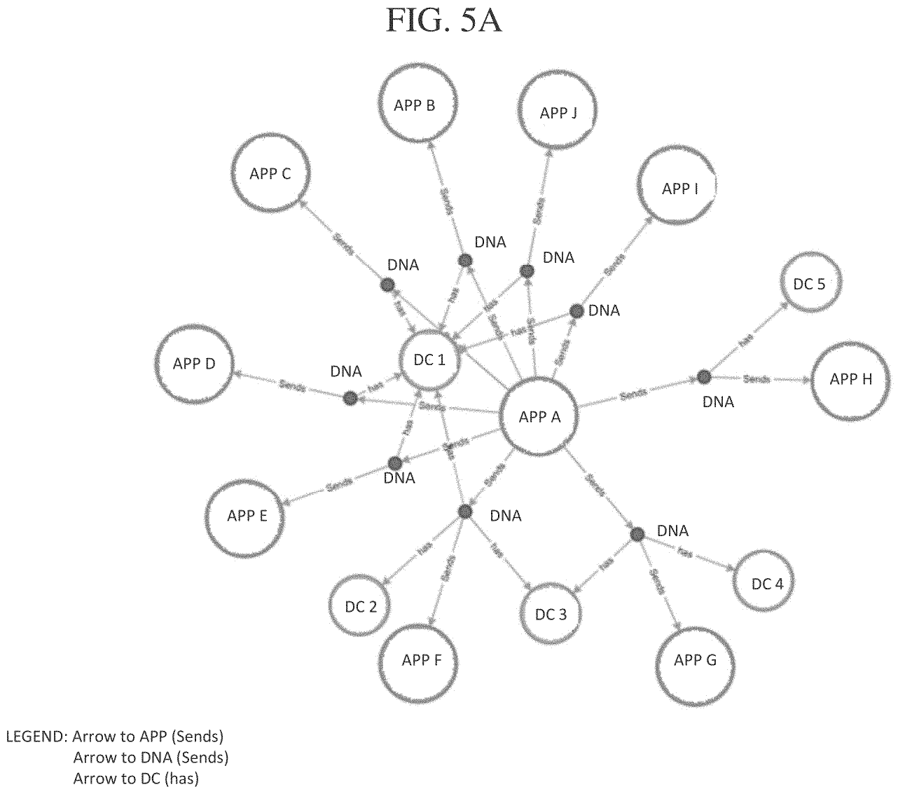

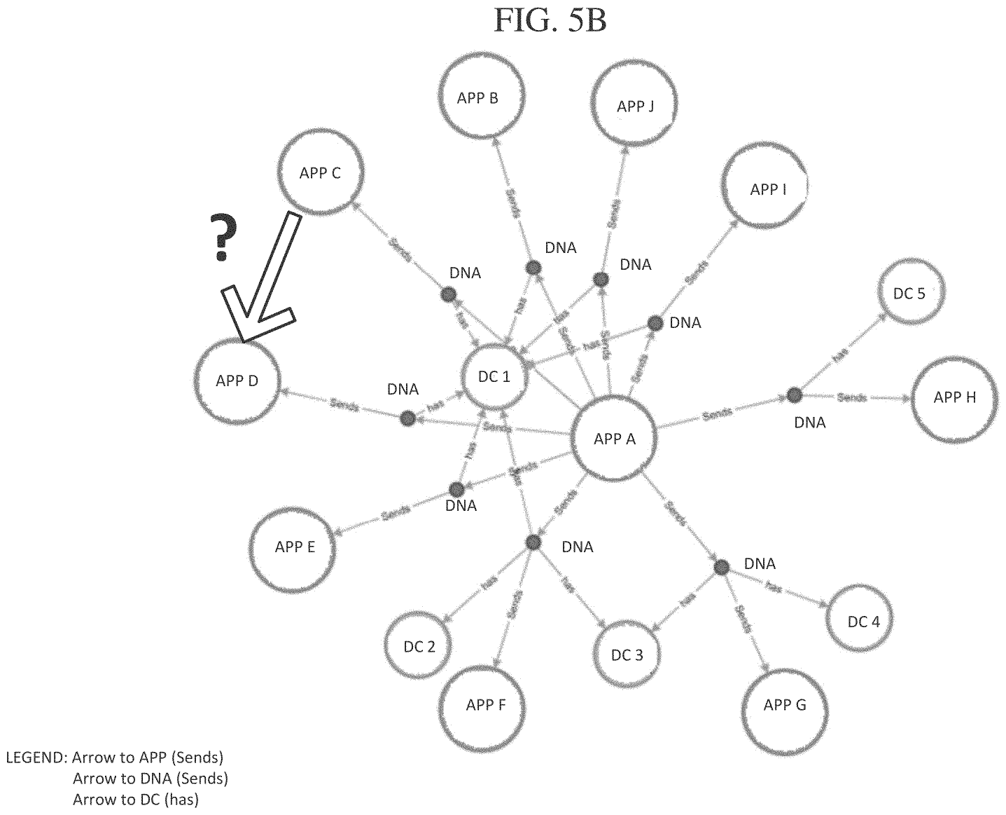

When multiple DNAs include the same or similar concepts, the corresponding dataflows may be understood to share the same data concept. When the DNA does not share a concept with other DNAs, the respective DNA is understood to be unique to the corresponding dataflow. The identified data concepts may be generated as additional graphical nodes in the graph with interconnectivity relationships with relevant DNAs. As exemplarily illustrated in FIG. 5A, a DNA may indicate a separate data concept, such as DC5, that is not shared with any other DNAs. Alternatively, multiple DNAs may provide or share a singular data concept, such as DC1. However, a relationship between various nodes not connected by a dataflow is unknown. For example, as illustrated in FIG. 5B, although a relationship between APP A and APP C may be clear, a relationship between APP C and APP D may not be determined based on the graph of FIG. 5B.

In operation S405, graph projection applied. in an example, graph projection may be performed to form a suitable structured for applying a graph algorithm for performing linked predictions between dataflows and data taxonomy. Data taxonomies may be obtained based on the generated graph. For example, data taxonomies may be synthetically derived from domains within the graph. Further, data taxonomies may be additionally or alternatively derived from words taken from description of capabilities or a listed dictionary terms (e.g., business concepts). Isomorphism mapping that preserves sets and relations among capabilities may be obtained. In an example, an isomorphism may indicate that node A is isomorphic to node B. Under a graph theory, bijection may bet formed between the vertex sets of A (f. V(B)→V(A)) such that any two vertices u and v of A are adjacent in B if f(u) and f(v) are adjacent in B. Such bijection may be referred to as edge-preserving bijection.

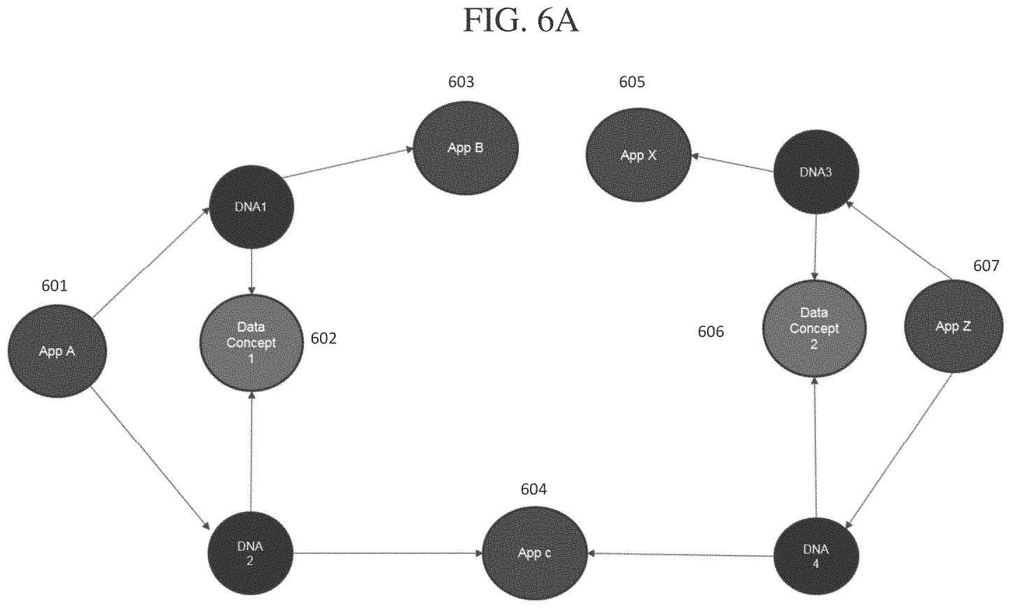

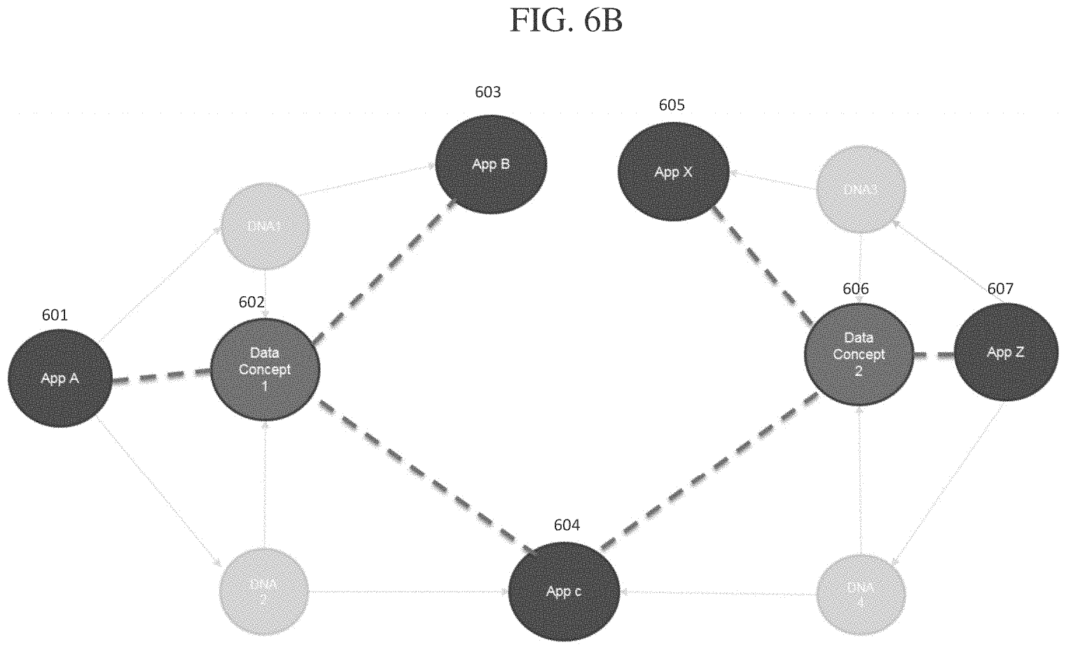

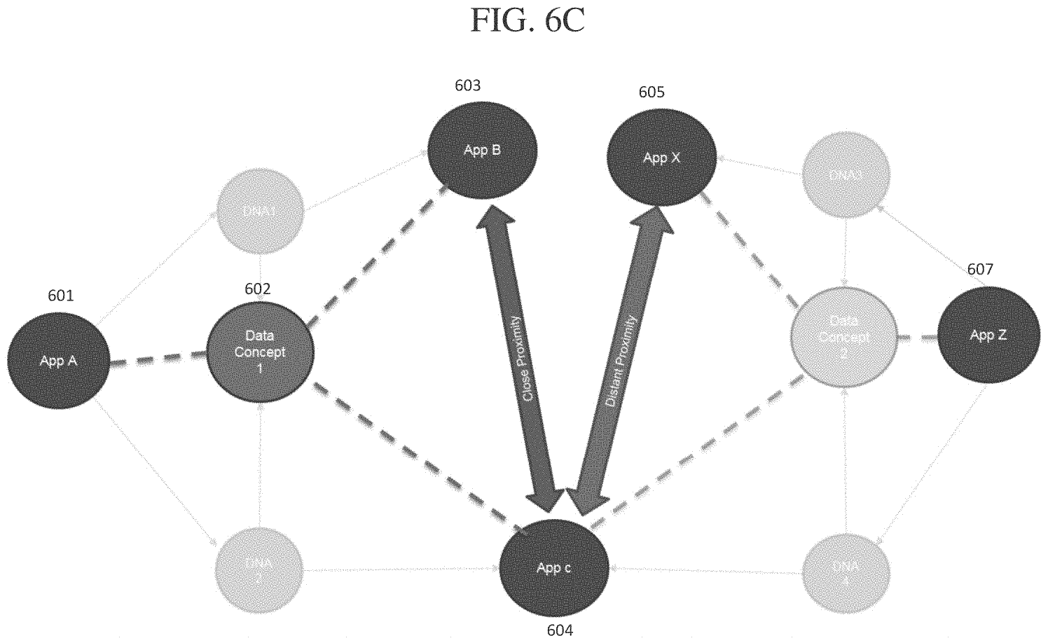

FIG. 6A illustrates a tripartite graph, namely the graph generated including the identified data entity nodes, DNA nodes, and data concept nodes. As illustrated in FIG. 6A, both App B 603 and App X 605 are indirectly connected to App C 604 and are associated with two different data concepts 602 and 606. More specifically, App A 601, App B 603, and App C 604 may be connected via the data concept 602. Similarly, App X 605, App Z 607 and App C 604 may be connected via the data concept 606.

Further, in FIG. 6A, App A 601 transmits data to App B 603, and App A 601 transmits data to App C 604 as indicated by the directional arrows. Accordingly, interconnectivity or relationship between App A 601 and App B 603 are known, as well as interconnectivity or relationship between App A 601 and App C 604. However, a relationship between App B 603 and App C 604 is unknown based on the graph of FIG. 6A, Similarly, in FIG. 6A, App Z 607 transmits data to App X 605, and App Z 607 transmits data to App C 604 as indicated by the directional arrows. Accordingly, interconnectivity or relationship between App Z 607 and App X 605 are known, as well as interconnectivity or relationship between App Z 607 and App C 604. However, a relationship between App X 603 and App C 604 is unknown.

Graph projection may be applied to the tripartite graph illustrated in FIG. 6A to generate a bipartite graph as illustrated in FIG. 6B. Although graph projection has been described for modifying a tripartite graph structure to a bipartite graph structure, aspects of the present disclosure is not limited thereto, such that an n-number partite graph structure may be modified to a bipartite graph structure.

As illustrated in FIG. 6B, graph projection is performed on the graph illustrated in FIG. 6A to provide a graph illustrating interconnections only between the data concepts 602 and 606, and App A 601, App B 603, App C 604, App X 605, and App Z 607. As illustrated in FIG. 6B each of the data entity nodes may be connected via one of the data concepts 602 and 606. For example, App A 601, App B 603, and App C 604 may be connected via the data concept 602. Similarly, App X 605, App Z 607 and App C 604 may be connected via the data concept 606. However, App B 603 and App C 604, although connected via the data concept 602, may not communicate with one another. In other words, no dataflow exists between App B 603 and App C 604. Similarly, no dataflow exists between App X 605 and App C 604.

In operation S406, a prediction algorithm is applied for the modified graph structure (e.g., bipartite graph illustrated in FIG. 6B) to determine predicted relationships or dataflows between two data entity nodes that are not directly connected with one another, but indirectly connected via a particular data concept. More specifically, a prediction algorithm may be executed to determine a possibility of dataflow between two data entity nodes with respect to a particular data entity. Further, the prediction algorithm may utilize one or more machine learning models for its calculation. Each of the machine learning models may correspond uniquely to a particular data concept. For example, a prediction with respect to data concept A may be calculated using machine learning model A, and a prediction with respect to data concept B may be calculated using machine learning model B.

In an example, the prediction algorithm may be a Random Forest Algorithm. However, aspects of the present application is not limited thereto. The prediction algorithm may include Adamic/Adar index, which may build upon common neighbor's algorithm. However, rather than just counting those neighbors, it computes the sum of the inverse log of the degree of each of the neighbors. The degree of a node may refer to a number of neighbors the node has. The algorithm may be premised on the idea that nodes of low degree are likely to be more influential. By applying the prediction algorithm, probabilistic scores for each capability combined with organization pairing, which are used as an input into the machine learning models, may be provided.

In parallel, natural language processing (NLP) is used to create a collection of words from all reference sources. For example, the NLP prediction algorithm may utilize various node information, such as descriptions, process types, taxonomies and other non-graph information to perform a prediction. Such collection may be increased as more reference information and associated links are added. Using natural language models, such as Naive Bayes, LinearSVC, Logic Regression, Random Forest and the like, machine learning models may be trained to find all of the data taxonomy concepts.

In an example, referring to FIG. 6B, a prediction algorithm may be applied to the bipartite graph structure to determine a probability of dataflow between App B 603 and App C with respect to data concept 602. In this regard, prediction algorithm utilizes a machine learning model that is specific to the data concept 602 to determine a probability of dataflow between the respective nodes with respect to the data concept 602. Prediction algorithm may also indicate a probability of dataflow between App C 604 and App X 605, As illustrated in FIG. 6C, the prediction algorithm may indicate a closer proximity between App B 603 and App C 604 than App X 605 and App C 604 with respect to data concept 602. Accordingly, a probability of dataflow being present between App B 603 and App C 604 is deemed more likely than a probability of dataflow being present between App X 605 and App C 604.

Each data concept may include its own machine learning model, which may be a graph type or a natural language type. In an example, the type of the machine learning model to be utilized in a prediction algorithm may be based on data distribution and frequency for a given concept. For example, a data distribution allowing a derived cut-off date with at least 0.70% of sample data to be used as training data may be a factor for considering using the graph type machine learning model.

In an example, the prediction algorithm may calculate a probability of a dataflow from data entity node X to data entity node Y (dataflow XY) or vice-versa with respected to connected data concepts. More specifically, the data entity nodes X and Y may be connected, directly or indirectly, to one or more data concepts. Accordingly, when the prediction algorithm is run for dataflow XY, probability of dataflow XY with respect to each of the connected data concepts may be calculated.

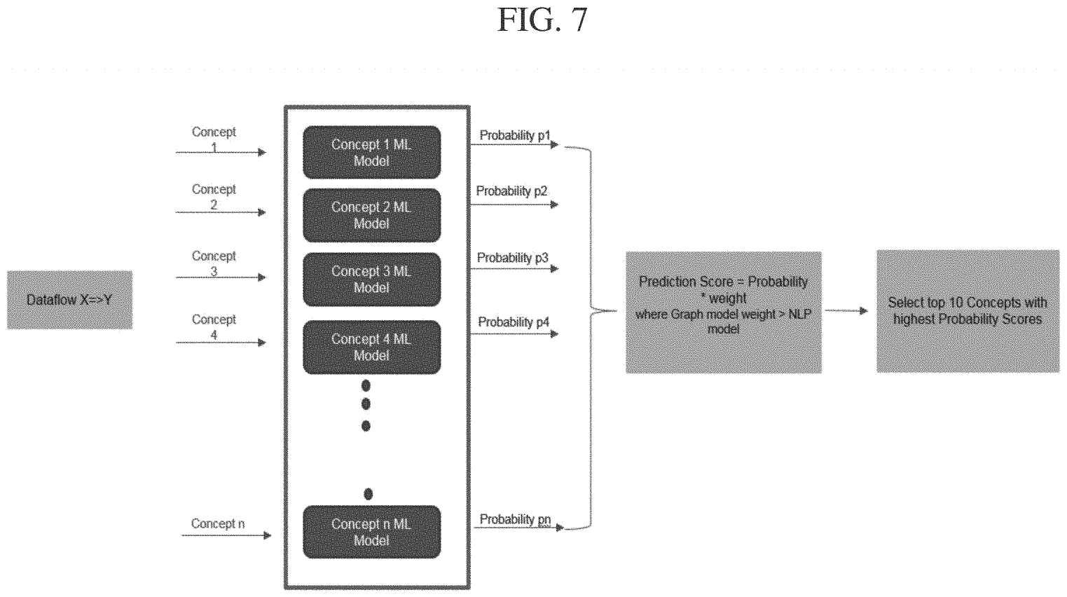

As exemplarily illustrated in FIG. 7, each data concept has a corresponding machine learning model that is fed into to determine a probability for the respective data concept for a particular dataflow. For example, data concept 1 may be inputted into a corresponding data concept 1 machine learning model to output probability p1 for the dataflow from node X to node Y (dataflow XY) with respect to the data concept 1. Similarly, data concept 2 may inputted into a corresponding data concept 2 machine learning model to output probability p2 for the dataflow XY with respect to the data concept 2.

Unlike a manual qualification that describes an existence of a dataflow, and not a lack of dataflow, aspects of the present application provide negative cases using negative correlation and ensure that a distribution is balanced between each data concept, positive and negative. Further, by utilizing the graph and sub-graph, training set and test-set data utilized to create and test machine learning models may be extracted.

The machine learning models may be built using a training set, and tested with the test set to provide model parameters. Each is trained against a set of DNA attested dataflows model algorithm examples, which include: Random Forest, Naïve Bayes, Logistic Regression and Xboost. Each machine learning model is evaluated as to its ability to accurately predict each data concept. Some machine learning models are better at predicting frequently occurring data concepts, other rarer data concepts. All of the machine learning models on the discovered dataflows to obtain prediction data for the data concepts, and direction of the dataflows. Further, the machine learning models may be applied on the discovered dataflows to predict data concepts weighted with the probability output calculated from the graph machine learning.

In operation S407, the probability values may be additionally factored by a weight that is applied based on whether a graph model prediction algorithm was utilized or natural language processing model prediction algorithm was utilized. In an example, higher weight may be applied if the graph model prediction algorithm was utilized as it provides a higher accuracy over the natural language processing model prediction algorithm. Based on a calculation based on the calculated probability and determined weight, a prediction score may be provided for each of the data concepts. Based on the prediction score, a select number ref top scoring data concepts may be displayed to a user for predicted data concepts corresponding to a particular dataflow of interest. After operation S407, the method loops back to operation S404 to be performed on another data concept.

For example, as illustrated in FIG. 7, probability for each data concept is calculated for dataflow XY using a prediction algorithm, whether graph model prediction algorithm or natural language processing model prediction algorithm. The calculated probabilities are then factored by a weight based on the prediction algorithm utilized. Higher weight is provided for probability values calculated using ale graph model prediction algorithm. Based on the probability and applied weight, prediction scores are calculated for each of the data concepts. Based on the prediction scores, data concepts having the top 10 prediction scores may be selected for display for the dataflow XY.

Based on the above noted disclosures, various technical benefits may be derived. Search space may be optimized by projecting high dimension space to lower dimensions. Further, computational complexity may be reduced for lower utilization of CPU processing. For example, at least since data classification may be performed based on surface level data utilized to generate a graph, CPU utilization may be reduced. Further, machine learning performance may be enhanced for higher accuracy by utilizing graph projections. Accordingly, based on the above, refined classification of data may be provided without detailed introspection of data content.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while die computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application mar encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for performing a projected graph based prediction, the method being implemented by at least one processor, the method comprising:
obtaining, by the at least one processor and via a network, a plurality of data from a plurality of servers;
determining, by the at least one processor and based on the obtained data, a plurality of data entities and a plurality of dataflows between the data entities;
generating, by the at least one processor, a first graph including, the data entities as nodes and the dataflows between the nodes;
identifying, by the at least one processor, a plurality of data concepts based on the obtained data;
inserting, by the at least one processor and onto the first graph, the identified data concepts to provide a second graph;
applying, by the at least one processor, a graph projection on the second graph to generate a sub-graph; and
determining, by the at least one processor and using a prediction algorithm via a plurality of machine learning models, a predicted dataflow between at least two nodes connected to a target data concept in the sub-graph.

2. The method of claim 1, wherein the plurality of data includes system log data, asset level data, monitoring data, and reference data.

3. The method of claim 2, wherein the reference data includes a dynamic network architecture corresponding to a dataflow between the nodes among the dataflows.

4. The method of claim 1, wherein at least one of the data concepts is connected to a plurality of dataflows.

5. The method of claim 1, wherein each of the plurality of data concepts is inputted to a corresponding machine learning model among the plurality of machine learning models.

6. The method of claim 1, wherein the graph projection includes modifying a tripartite graph structure to a bipartite graph structure.

7. The method of claim 1, wherein the graph projection includes modifying n-number partite graph structure to a bipartite graph structure.

8. The method of claim 1, wherein, in the predicting, probabilities of the predicted dataflow are calculated for the plurality of data concepts.

9. A computing apparatus for performing a projected graph based prediction, the computing apparatus comprising:
a processor;
a memory; and
a communication interface coupled to each of the processor and the memory,
wherein the processor is configured to:
obtain, via a network, a plurality of data from a plurality of servers;
determine, based on the obtained data, a plurality of data entities and a plurality of dataflows between the data entities;
generate a first graph including the data entities as nodes and the dataflows between the nodes;
identify a plurality of data concepts based on the obtained data;
insert onto the first graph, the identified data concepts to provide a second graph;
apply a graph projection on the second graph to generate a sub-graph; and
determine, using a prediction algorithm via a plurality of machine learning models, a predicted dataflow between at least two nodes connected to a target data concept in the sub-graph.

10. The computing apparatus of claim 9, wherein the plurality of data includes system log data, asset level data, monitoring data, and reference data.

11. The computing apparatus of claim 10, wherein the reference data includes a dynamic network architecture corresponding to a data low between the nodes among the dataflows.

12. The computing apparatus of claim 9, wherein at least one of the data concepts is connected to a plurality of dataflows.

13. The computing apparatus of claim 9, wherein each of the plurality of data concepts is inputted to a corresponding machine learning model among the plurality of machine learning models.

14. The computing apparatus of claim 9, wherein the graph projection includes modifying a tripartite graph structure to a bipartite graph structure.

15. The computing apparatus of claim 9, wherein the graph projection includes modifying n-number partite graph structure to a bipartite graph structure.

16. The computing apparatus of claim 9, wherein probabilities of the predicted dataflow are calculated for the plurality of data concepts.

17. A non-transitory computer readable storage medium that stores a computer program for performing a projected graph based prediction, the computer program, when executed by a processor, causing a system to perform a process comprising:
obtaining, via a network, a plurality of data from a plurality of servers;
determining, based on the obtained data, a plurality of data entities and a plurality of dataflows between the data entities;
generating a first graph including the data entities as nodes and the dataflows between the nodes:
identifying a plurality of data concepts based on the obtained data;
inserting, onto the first graph, the identified data concepts to provide a second graph;
applying a graph projection on the second graph to generate a sub-graph; and
determining, using a prediction algorithm via a plurality of machine learning models, a predicted dataflow between at least two nodes connected to a target data concept in the sub-graph.

18. The non-transitory computer readable storage medium of claim 17, wherein each of the plurality of data concepts is inputted to a corresponding machine learning model among the plurality of machine learning models.

19. The non-transitory computer readable storage medium of claim 17, wherein the graph projection includes modifying a tripartite graph structure to a bipartite graph structure.

20. The non-transitory computer readable storage medium of claim 17, wherein the graph projection includes modifying, n-number partite graph structure to a bipartite graph structure.
